(19) United States
(12) Patent Application Publication
(10) Pub. No.: US 2025/0358128 A1
(43) Pub. Date: Nov. 20, 2025

(54) PRIVACY-PRESERVING MACHINE-LEARNING SYSTEM AND METHOD FOR AUTOMATED COMPETENCY TAGGING AND LEARNING-OBJECT DATA REMAPPING

(71) Applicant: Estia Inc., San Antonio, TX (US)

(72) Inventors: Alejandra Zertuche, San Antonio, TX (US); Onyekachi Okoye, San Antonio, TX (US); James William Absalon, San Antonio, TX (US); John Thornton, II, Austin, TX (US)

(73) Assignee: Estia Inc., San Antonio, TX (US)

(21) Appl. No.: 19/204,060

(22) Filed: May 9, 2025

Related U.S. Application Data
(60) Provisional application No. 63/647,172, filed on May 14, 2024.

(51) Int. Cl. H04L 9/32

(52) U.S. Cl. CPC H04L 9/3236

(57) ABSTRACT

A computing system is disclosed for classifying rendered learning-object content and generating structured metadata representing competency and depth-of-knowledge attributes. The system detects rendered instructional content within a user interface and generates a cryptographic hash of the content, which is encrypted with session metadata to form a classification request. The request is transmitted to a remote categorization engine, where the content is processed using embedding models and inference classifiers to determine one or more competency labels, knowledge depth values, and confidence scores. The classification result is encrypted and returned to the client device for interface rendering. Classification records, including feedback interactions and associated metadata, are stored for use in model retraining.

### CROSS-REFERENCE TO RELATED APPLICATIONS

This application claims priority to U.S. Application No. 63/647,172, entitled “SYSTEMS AND METHODS FOR EVALUATING A CURRICULUM,” filed May 14, 2024, the full disclosure of which is incorporated herein by reference for all purposes.

### FIELD OF THE ART

The systems and methods disclosed herein relate generally to computer-implemented machine-learning data processing and, more specifically, to privacy-preserving systems for automated competency tagging, depth-of-knowledge classification, and adaptive remapping of educational content.

### BACKGROUND

Educational technology platforms routinely store and deliver vast quantities of digital learning content—exam questions, assignments, program outcomes, and course objectives—distributed across multiple learning-management systems and assessment databases. Tagging each learning object with the correct competency identifier and depth-of-knowledge level is traditionally performed by instructors through manual drop-down selection or spreadsheet work, a process that is slow, error-prone, and operationally impractical when course materials number in the thousands.

Automated tagging tools presently in use rely primarily on keyword matching or static rule templates. These techniques are brittle when confronted with synonym drift, acronym variation, and discipline-specific terminology, resulting in inconsistent or incomplete metadata. In many cases they also require separate passes—or entirely separate utilities—to assign depth-of-knowledge ratings, thereby duplicating processing effort and propagating classification latency.

A further technical limitation is that conventional tagging services frequently require wholesale upload of raw assessment content to external servers. This exposes proprietary question banks to privacy risks and intellectual-property leakage, and forces the same item to be re-processed each time it is encountered, unnecessarily consuming compute resources.

Curricular alignment becomes even more complex when accrediting bodies update competency frameworks. Existing systems provide no scalable mechanism for re-mapping hundreds of course objectives to a revised standard, leaving institutions to perform manual spreadsheet-based reconciliation that is susceptible to versioning errors and audit gaps.

Current classifier tools are typically static and lack mechanisms for ingesting instructor feedback to correct misclassifications over time. As a result, model errors persist across successive terms, reducing trust in analytic dashboards and hindering data-driven curriculum management.

Accordingly, improved computer-implemented techniques for large-scale competency and depth-of-knowledge tagging of educational content are desirable.

### SUMMARY

Systems and methods in accordance with the embodiments described herein overcome various deficiencies in existing approaches to automated tagging and classification of digital content items, duplicate processing of learning objects, and large-scale realignment of metadata. In particular, various embodiments provide privacy-preserving, machine-learning data-processing techniques that operate on encrypted content hashes to generate competency labels and depth-of-knowledge classifications while minimizing computational redundancy and safeguarding proprietary materials.

For example, in some embodiments a browser-resident plug-in detects rendering of a learning object within a learning-management interface, computes a non-reversible cryptographic hash of the object text, encrypts the hash together with limited context, and transmits the encrypted payload to a remote processing platform via a secure network connection. In alternative embodiments, the same processing platform receives learning-object data directly from a content repository or LMS application-programming interface (API), applies the hashing and encryption logic server-side, and proceeds as described below.

The processing platform compares each received hash—whether sourced from the plug-in or an API feed—to a deduplication cache; when a matching entry is located, previously generated metadata is returned without invoking additional inference operations. When no match exists, the payload is forwarded to a categorization engine that, during a single inference pass, produces a competency label and a depth-of-knowledge level accompanied by confidence scores.

The generated metadata is stored in association with the hash within a persistent storage cluster and is simultaneously streamed back to the plug-in, which renders the classification results in the instructor interface without exposing original assessment content.

Feedback signals indicating acceptance or revision of the returned classifications are collected at the client, persisted in a feedback log within the storage cluster, and periodically consumed by a weighting algorithm that assembles an updated training corpus for a scheduled retraining job; the resulting model version is deployed while earlier checkpoints remain archived for audit integrity.

Upon receipt of an updated competency framework, a remapping routine executes to convert existing competency labels to the revised framework, identify any unmapped gaps, and persist the resulting alignment data for downstream reporting and analytics.

Advantageously, the embodiments disclosed herein improve computer-implemented machine-learning data processing by reducing redundant compute cycles through cryptographic hash-based de-duplication, preserving data privacy by transmitting only encrypted, content-agnostic payloads to the classifier, and lowering latency by generating competency and depth-of-knowledge metadata in a single inference pass. Further, a feedback-weighted retraining pipeline incrementally refines model accuracy without manual rule updates, and an automated remapping routine programmatically realigns stored competency labels to revised accreditation frameworks, replacing spreadsheet-driven workflows with a scalable, audit-ready process.

Accordingly, in accordance with various embodiments, approaches described herein provide a computing system that enables real-time classification of instructional content based on what the content is teaching and how cognitively demanding it is-without requiring access to the content itself. This classification enables the system to determine which skill or educational concept each learning activity addresses, thereby supporting alignment between observed instructional content and expected competency frameworks A plug-in operating within a browser-based learning environment detects when a piece of educational content (such as a quiz item or learning objective) is rendered to the user, computes an encrypted fingerprint of that content, and sends it to a backend system. There, machine learning models classify the encrypted fingerprint into a competency tag (e.g., what subject or skill it represents) and a complexity level (e.g., how hard it is), and return those results to the user interface. The content remains private throughout the process. Educators can see and respond to the classifications, and their feedback is used to improve the model over time. The system also includes automated tools to re-map old classifications when a competency framework changes, enabling scalable alignment across instructional materials.

Various other functions and advantages are described and suggested below in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an example architecture of an automated competency-tagging and data-remapping system in accordance with an embodiment.

FIG. 2 illustrates an example configuration of plug-in in accordance with an embodiment.

FIG. 3 illustrates an example configuration of categorization engine in accordance with various embodiments.

FIG. 4 illustrates an exemplary process for classifying learning-object content and providing encrypted classification results, in accordance with various embodiments.

FIG. 5 illustrates an exemplary process for generating and encrypting a content hash derived from rendered learning-object content, in accordance with various embodiments.

FIG. 6 illustrates an exemplary process for determining a classification result for rendered learning-object content, in accordance with various embodiments.

FIG. 7 illustrates an exemplary process for recording classification outcomes and storing structured records for model retraining, in accordance with various embodiments.

FIG. 8 illustrates an example device-level architecture that can support various embodiments.

FIG. 9 illustrates components of a computing device in accordance with various embodiments.

FIG. 10 illustrates an exemplary architecture of a system in accordance with various embodiments.

FIG. 11 illustrates components of a computing device in accordance with various embodiments.

### DETAILED DESCRIPTION

The embodiments described herein relate to computer-implemented machine-learning data-processing systems that automate the generation, persistence, and continual refinement of competency and depth-of-knowledge metadata for digital content items. The system ingests content through a client-side capture layer that hashes and encrypts on-screen materials—or, in alternative embodiments, through a direct repository feed—compares each resulting hash to a deduplication cache to bypass redundant inference, and, when no match is detected, forwards an encrypted payload to a categorization engine that produces, in a single inference pass, a competency label and a cognitive-complexity score with confidence metrics. In various embodiments, the system further includes a feedback-weighting service that aggregates acceptance or correction signals, schedules retraining jobs, and deploys versioned model checkpoints, together with a remapping service that programmatically realigns stored metadata to revised competency frameworks. By integrating these automated computational processes, the system reduces processor load, safeguards proprietary content, and delivers continuously improving metadata without manual template maintenance, thereby addressing technical constraints that have limited prior automated tagging solutions.

Accordingly, in accordance with various embodiments, the present disclosure provides a computing system operable to determine, in real time and without access to original content, what a rendered instructional item is teaching and how cognitively demanding it is. This classification enables the system to determine which skill or educational concept each learning activity addresses, thereby supporting alignment between observed instructional content and expected competency frameworks. The system includes a plug-in or interface module that observes when a learning-object item—such as an assessment question or instructional objective—is displayed within a browser-based learning environment. Upon detection, the system computes a non-reversible, encrypted fingerprint of the item and transmits it to a remote classification service. There, machine-learned inference models determine a competency label that corresponds to a domain-specific concept or skill and a depth-of-knowledge value that reflects the item's cognitive complexity. The resulting classification metadata is returned to the interface for rendering and may be stored for downstream audit, feedback weighting, or retraining. Feedback received from instructors—such as accepting or modifying the classification—is incorporated into model refinement workflows. Additionally, when a new competency framework is adopted, the system includes a remapping component that aligns existing stored metadata to the updated taxonomy. These combined processes enable privacy-preserving, scalable, and curriculum-aligned tagging of instructional content across learning systems.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. A Iso, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

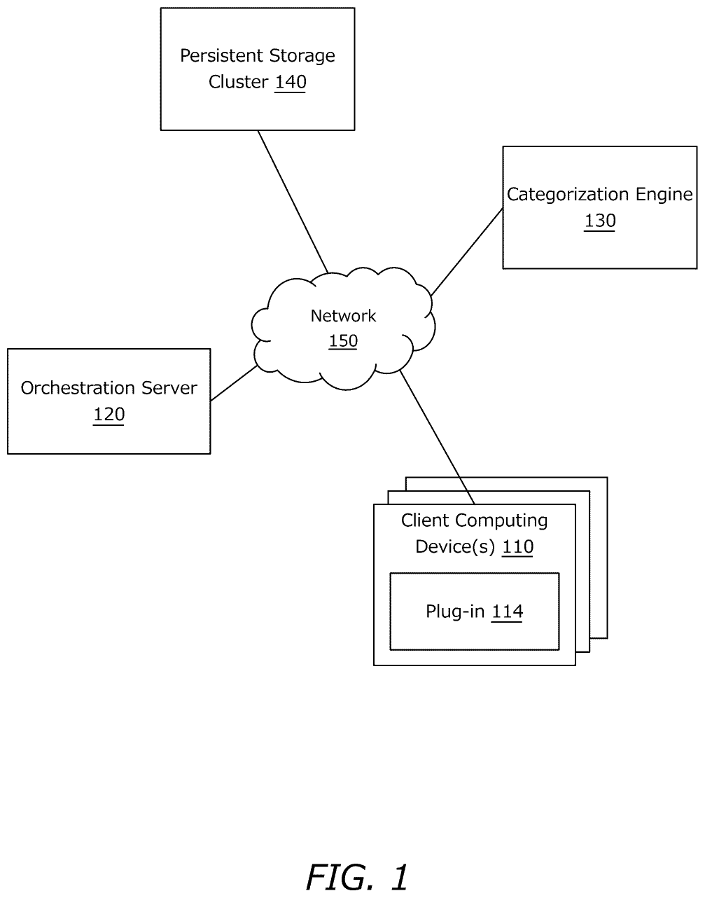

FIG. 1 illustrates an example architecture of an automated competency-tagging and data-remapping system in accordance with an embodiment. It should be understood that reference numbers are carried over between figures for similar components for purposes of simplicity of explanation, but such usage should not be construed as a limitation on the various embodiments unless otherwise stated. As shown in FIG. 1, the system includes client computing device(s) 110, plug-in 114, network 150, orchestration server 120, categorization engine 130, and persistent storage cluster 140.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Orchestration server 120 is operable to coordinate secure, low-latency exchange of learning-object metadata between client computing device(s) 110 and downstream processing components. M ore specifically, orchestration server 120 exposes authenticated REST endpoints that accept encrypted hash payloads generated by plug-in 114, decrypts the payloads using a server-side private key, and consults an in-memory classification cache—in this context, a bounded key-value store mapping content hashes to previously issued competency results—to avoid redundant inference calls. When a cache miss occurs, orchestration server 120 forwards the normalized content representation to categorization engine 130 over network 150, awaits a competency-mapping response, and then re-encrypts and returns the response to the requesting plug-in 114. Concurrently, orchestration server 120 appends the request-response pair, along with any user-supplied feedback signals, to an append-only message queue residing in persistent storage cluster 140 for scheduled model-retraining jobs.

For example, when orchestration server 120 receives a POST request directed to a classification endpoint, the request may include a JSON Web Encryption (JWE) object comprising a cryptographic hash of a learning-object item, a timestamp indicating when the item was rendered, and an initialization vector associated with the client session. Orchestration server 120 is operable to decrypt the payload, extract the hash, and perform a lookup against a classification cache. In response to a cache miss, orchestration server 120 transmits the corresponding normalized content to categorization engine 130 over network 150 using a structured remote procedure call, such as gRPC. Upon receiving classification results-such as a competency label, a depth-of-knowledge designation, and one or more associated confidence scores orchestation server 120 may store the results in the cache with a time-to-live value, encrypt the response for the requesting client computing device 110, and return the classification via an HTTP response. For example, the classification result may be cached for a 24-hour period, after which the entry expires and is eligible for eviction. If a subsequent correction is received from plug-in 114—indicating, for example, that the returned label should be modified—orchestation server 120 appends the correction to a retraining queue stored in persistent storage cluster 140 for future inclusion in a scheduled model update.

In certain embodiments, orchestration server 120 further assigns version identifiers to classification responses based on the active model deployed by categorization engine 130 at the time of inference. Each response returned to plug-in 114 may include this version identifier, enabling downstream validation, auditability, or rollback. Feedback submissions received from client computing device(s) 110 are stored in temporal order, tagged with the associated model version, and may be filtered or prioritized during retraining. If an incoming request contains a malformed payload, an unrecognized encryption envelope, or a hash not conforming to expected length or format constraints, orchestration server 120 is operable to reject the request, log the event to a secure monitoring queue, and issue an appropriate response code to the requesting client. In certain embodiments, orchestration server 120 may also expose a metrics interface or administrative endpoint operable to retrieve inference counts, cache-hit ratios, and feedback distributions for operational monitoring or external audit.

Categorization engine 130 is operable to generate structured metadata representations for digital learning-object content, including competency classifications, depth-of-knowledge ratings, and associated confidence values. M ore specifically, categorization engine 130 receives normalized representations of learning objects—either directly or via orchestration server 120—applies one or more machine-learned models to infer applicable competency tags and cognitive complexity scores, and returns the results in a structured format for downstream persistence or display. In certain embodiments, categorization engine 130 executes on dedicated compute infrastructure and exposes a remote procedure call interface (e.g., gRPC) through which orchestration server 120 may submit classification requests. Internally, categorization engine 130 may include pre-processing logic to tokenize or sanitize the input text, an embedding generator that transforms the input into a fixed-dimensional representation, and one or more classifier heads configured to output label predictions.

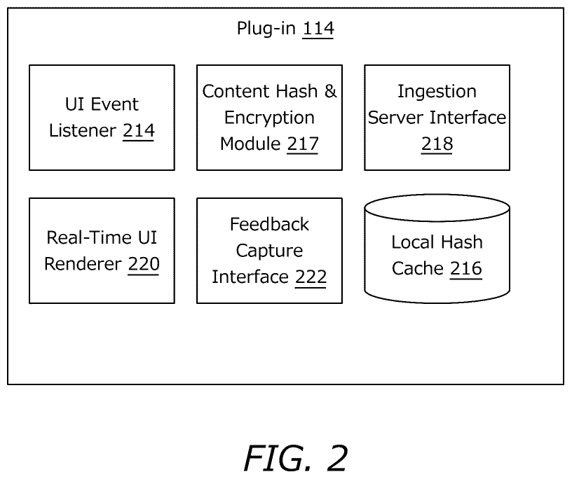

For example, categorization engine 130 may receive a normalized learning-object string and apply an embedding model (e.g., a transformer-based encoder) to project the content into vector space. The resulting vector is passed through a multi-label classifier that assigns one or more competency identifiers, and through a parallel classifier that predicts a depth-of-knowledge value (e.g., “level 1” through “level 4”). Each prediction is returned with an associated confidence score (e.g., softmax probability or margin-based distance). In some embodiments, categorization engine 130 may also annotate each output with a model version identifier, timestamp, or model-decoding metadata for audit or interpretability purposes. Classification results are returned to orchestration server 120 for encryption and transmission to plug-in 114, and may also be written to persistent storage cluster 140 for caching and retraining workflows. Additional details of categorization engine 130 are described in FIG. 2 below.

Persistent storage cluster 140 is operable to store and organize learning-object metadata, classification results, model feedback records, and retraining inputs generated by components of the system. M ore specifically, persistent storage cluster 140 comprises one or more structured data repositories configured to persist encrypted payloads, classification outputs, confidence scores, feedback signals, model version identifiers, and remapping artifacts. The storage layout may include logically distinct tables or document collections for processed classification results, hash-to-label mappings, instructor feedback events, version-controlled model checkpoints, and historical framework-alignment data. In various embodiments, persistent storage cluster 140 is accessible by orchestration server 120 and categorization engine 130 via authenticated interfaces over network 150, and is operable to support both transactional write operations and batched read access for model-retraining workflows.

For example, when orchestration server 120 receives classification output for a learning-object hash, it may write a structured record to persistent storage cluster 140 containing: (i) the hash value; (ii) the predicted competency label and depth-of-knowledge level; (iii) associated confidence metrics; (iv) the classification timestamp; and (v) a model version identifier. If feedback is later submitted through plug-in 114 to revise or confirm a classification, orchestration server 120 appends a corresponding feedback entry—tagged with the original hash and version metadata—to a feedback log table. Categorization engine 130 may periodically retrieve entries from the feedback log and associated hash records for use in retraining the deployed model. In some embodiments, persistent storage cluster 140 may also maintain remapping tables that track the correspondence between previously predicted labels and newly adopted frameworks, enabling auditability and continuity when competency standards are updated.

The system may also include additional subsystems and databases not illustrated in FIG. 1, but which would be readily understood by a person of ordinary skill in the art. For example, the system may include auxiliary databases for storing competency framework definitions, historical alignment mappings, model evaluation results, or retraining configurations. In certain embodiments, the system may interface with external accreditation systems, learning management platforms, or curriculum review tools to support program-wide reporting, audit workflows, or standards compliance. Additional subsystems and integrations may be added, removed, or reconfigured without departing from the scope of the present disclosure.

FIG. 2 illustrates an example configuration of plug-in 114 in accordance with an embodiment. As shown, plug-in 114 includes UI event listener 214, local hash cache 216, content hash and encryption module 217, ingestion server interface 218, real-time UI renderer 220, and feedback capture interface 222. In various embodiments, plug-in 114 is operable to detect rendered learning-object content, compute and encrypt a hash-based representation of the content, transmit the resulting payload to orchestration server 120 via ingestion server interface 218, and render classification results in response. In addition, plug-in 114 is operable to capture user input indicating acceptance or correction of the rendered classification and transmit the resulting feedback for further processing. Although described herein in the context of a browser-executed plug-in, the described functionality of plug-in 114 may be implemented in other environments, such as native applications or embedded display contexts, without departing from the scope of the system. The components of plug-in 114 shown in FIG. 2 are described in greater detail below.

Ingestion server interface 218 is operable to manage the exchange of encrypted payloads and classification responses between plug-in 114 and orchestration server 120 over network 150. In various embodiments, ingestion server interface 218 includes one or more outbound request modules configured to transmit encrypted classification requests and inbound response handlers operable to receive structured tagging results. The interface may support HTTP-based protocols, such as POST and PATCH, for transmitting JSON Web Encryption (JWE) objects that encapsulate hash values, session metadata, and initialization vectors. In certain implementations, ingestion server interface 218 supports symmetric or asymmetric encryption protocols and may incorporate session-based authentication tokens to validate transmission origin. The present disclosure contemplates any encrypted payload that includes a cryptographic hash of a learning-object item, session metadata such as timestamps or IP addresses, and associated encryption metadata; and any classification response that includes one or more predicted labels, a depth-of-knowledge value, confidence metrics, and optionally, a model version identifier.

More specifically, ingestion server interface 218 packages each outbound request from plug-in 114 with a payload generated by content hash and encryption module 217. Prior to transmission, the interface may validate the payload structure to ensure inclusion of required fields, proper formatting of hash values, and presence of expected encryption metadata. The payload is transmitted over a TLS-secured channel to an endpoint exposed by orchestration server 120. The interface includes error detection and response-handling logic to monitor connectivity status, interpret HTTP response codes (e.g., 200, 400, 403), and, when needed, trigger retry logic or client-side logging. In some embodiments, ingestion server interface 218 may attach additional metadata, such as plug-in version, client locale, or session fingerprint, to support audit logging or downstream classification analysis. Upon receiving a classification response-containing predicted competency tags, depth-of-knowledge scores, and confidence metrics-ingestion server interface 218 passes the results to real-time UI renderer 220 for interface injection, and may also expose an event hook to notify feedback capture interface 222 that a new item is available for interaction.

For example, when content hash and encryption module 217 produces an encrypted payload, ingestion server interface 218 transmits the payload using an HTTPS POST request to an/api/classify endpoint exposed by orchestration server 120. The server responds with a JSON structure including the competency label, depth-of-knowledge level, confidence score, and optional model version identifier. Ingestion server interface 218 receives the response, validates its structure, and emits a browser event to update the corresponding on-screen element. If the request fails due to network timeout or malformed payload, the interface logs the error locally and attempts resubmission according to a configured backoff policy. In some embodiments, ingestion server interface 218 may also be configured to transmit periodic heartbeat messages, operate over persistent websocket connections, or receive batch inference results when operating in offline or queued-processing modes.

UI event listener 214 is operable to identify rendered learning-object content for classification within client computing device(s) 110. UI event listener 214, in various embodiments, determines when a relevant item-such as an assessment question or instructional element has been presented to a user interface in a manner sufficient to trigger downstream processing. M ore specifically, UI event listener 214 monitors the rendering environment for qualifying visibility or user-interaction conditions and emits structured event data to initiate content hashing. The listener may detect interface events through direct observation of the Document Object Model (DOM), frame lifecycle hooks, or render completion signals propagated by the host application. In some embodiments, UI event listener 214 establishes a persistent observer on a defined region of the display interface—such as a content container rendered by a learning management system—and listens for DOM mutations, intersection events, or text node insertions. Detected events are filtered using query selectors, debounced using internal timestamps or session-state tokens, and, when valid, packaged into an event object containing the DOM path, content text, layout metadata, and a timestamp. The event object is emitted to an internal processing bus for use by content hash and encryption module 217.

For example, UI event listener 214 may register an IntersectionObserver tied to a specific CSS class used by all rendered questions. When a new question scrolls into view and crosses a 75% visibility threshold, the listener triggers a callback that queries the DOM for the associated text content, records the timestamp, and constructs an event object {elementPath, visibilityState, timestamp, contentText}. This object is then passed downstream to initiate hashing and classification. In some embodiments, UI event listener 214 may also include configuration flags that restrict triggers to unique items within a given session, ignore non-gradable components, or apply additional contextual filters (e.g., restrict to items inside timed assessments). The output of UI event listener 214 defines the scope and timing of content capture operations executed by subsequent components within plug-in 114.

Content hash and encryption module 217 is operable to generate a non-reversible cryptographic representation of rendered learning-object content and to construct an encrypted payload suitable for transmission to orchestration server 120. Content hash and encryption module 217, in various embodiments, receives structured event data from UI event listener 214, normalizes the textual content of the learning-object item, computes a fixed-length cryptographic hash, and encrypts the resulting value along with session metadata to form a transmission-ready object. More specifically, content hash and encryption module 217 may apply a cryptographic hash function (e.g., SHA-256) to the normalized content and package the result with metadata such as a timestamp, a content identifier, and a client-specific initialization vector. The module then encrypts the assembled payload using either a symmetric or asymmetric scheme, depending on the implementation configuration.

For example, when UI event listener 214 emits an event object containing a DOM path and extracted text content, content hash and encryption module 217 may first strip markup and whitespace artifacts, apply text normalization routines (e.g., case folding or stop-word removal), and compute a SHA-256 hash of the cleaned string. The resulting hash value is combined with a timestamp and a per-session initialization vector and encrypted using the public key of orchestration server 120. The output is formatted as a JWE (JSON Web Encryption) object and passed to ingestion server interface 218 for transmission. In some embodiments, content hash and encryption module 217 may include built-in support for rotating encryption keys, validating payload schema compliance, or logging internal hash collisions for analytical review.

Local hash cache 216 is operable to maintain a record of previously processed learning-object hashes to avoid redundant classification requests. In various embodiments, local hash cache 216 stores recent hash values in session-scoped memory, such as an in-memory key-value map, where each key corresponds to a cryptographic hash and each value represents the associated classification status or submission metadata. The cache may implement eviction logic—such as a least-recently-used (LRU) policy or a size-bound limit—to optimize memory use. In certain embodiments, the cache may persist across sessions or be backed by a durable client-side data store.

For example, when content hash and encryption module 217 generates a new SHA-256 hash for a learning-object item, local hash cache 216 performs a lookup on the hash to determine whether it has been previously encountered. If the hash is present and marked as recently submitted, no further request is triggered. If absent, the hash is added to the cache, optionally annotated with a timestamp, classification status flag, or pending submission state. In some embodiments, local hash cache 216 may be implemented as a Map or Set object in JavaScript, backed by session memory or a short-lived client-side data store such as IndexedDB. The presence of local hash cache 216 allows plug-in 114 to reduce unnecessary network traffic, conserve client compute resources, and prevent duplicate inference submissions to orchestration server 120.

Real-time UI renderer 220 is operable to display classification results associated with a learning-object item within the user interface of client computing device(s) 110. Real-time UI renderer 220, in various embodiments, receives structured classification responses from ingestion server interface 218, associates each response with the corresponding rendered content element, and injects the output into the active view without altering the underlying learning-object content. More specifically, real-time UI renderer 220 is operable to bind classification labels—such as competency tags, depth-of-knowledge values, and associated confidence scores—to user interface elements using client-side rendering logic. Rendering behaviors may be defined through configurable formatting rules or styling templates, and renderer operations may execute asynchronously to minimize interface disruption.

For example, real-time UI renderer 220 may identify the DOM node corresponding to a learning-object item using metadata propagated with the classification response or passed from UI event listener 214. Upon locating the target element, the renderer may insert an adjacent annotation element or overlay-containing labels such as “Quantitative Reasoning,” “Level 2,” and a visual confidence bar-styled according to system configuration or user preferences. In some embodiments, real-time UI renderer 220 may debounce update frequency to avoid excessive reflows, emit accessibility attributes for screen reader compatibility, or expose hoverable tooltips that display underlying confidence metrics or model version identifiers. The output of real-time UI renderer 220 enables client-side users to view classification results in-line while preserving the integrity of the original instructional content.

Feedback capture interface 222 is operable to collect user interactions associated with classification results and transmit those inputs for downstream model refinement and audit logging. Feedback capture interface 222, in various embodiments, listens for explicit user actions-such as accept, reject, or modify-applied to rendered competency and depth-of-knowledge labels generated by real-time UI renderer 220. When an action is detected, the interface assembles a structured feedback object containing the classification context (e.g., hash value, displayed labels, model version), user interaction type, timestamp, and optionally, any revised values entered by the user. The structured object is then encrypted and routed through ingestion server interface 218 to orchestration server 120, where it is stored in a retraining queue maintained within persistent storage cluster 140.

For example, when a user clicks an “Edit” button associated with a displayed classification, feedback capture interface 222 may retrieve the current label values, expose a modification panel, and upon submission, package the revised input into a structured payload including both the original and updated values. If the user instead confirms the original classification using an “Accept” control, the interface may generate a minimal acknowledgment record referencing the hash and model version. In either case, feedback capture interface 222 ensures that user input is time-aligned with the rendered content and properly associated with the classification event that triggered it. In some embodiments, the interface may debounce repeated actions, track input focus or hesitation timing, or provide hooks for audit overlays or confidence-threshold overrides prior to submission.

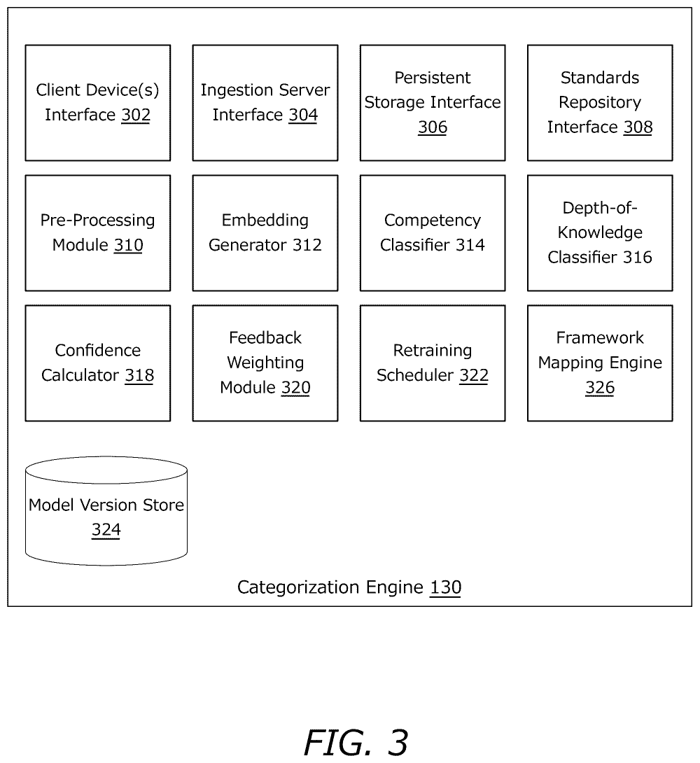

FIG. 3 illustrates an example configuration of categorization engine 130 in accordance with various embodiments. As shown, categorization engine 130 includes client device(s) interface 302, ingestion server interface 304, persistent storage interface 306, standards repository interface 308, pre-processing module 310, embedding generator 312, competency classifier 314, depth-of-knowledge classifier 316, confidence calculator 318, feedback weighting module 320, retraining scheduler 322, model version store 324, and framework mapping engine 326. It should be understood that reference numbers are carried over between figures for similar components for purposes of simplicity of explanation, but such usage should not be construed as a limitation on the various embodiments unless otherwise stated.

Client device(s) interface 302 is operable to manage inbound communications from client computing device(s) 110 to categorization engine 130. In various embodiments, client device(s) interface 302 receives encrypted classification requests transmitted by plug-in 114 and routed through orchestration server 120. The interface is configured to decrypt incoming requests using the appropriate cryptographic key, validate the structure of the decrypted payload, and extract content hashes and session metadata for downstream processing.

More specifically, client device(s) interface 302 includes one or more authenticated API endpoints that accept structured requests containing JSON Web Encryption (JWE) objects. Upon receipt, the interface validates the authentication token, decrypts the payload using a server-managed private key, and performs schema validation to ensure the presence of required fields such as content hash, timestamp, and session context. The extracted payload is normalized into an internal request format and forwarded to pre-processing module 310 for vectorization and classification. In certain embodiments, client device(s) interface 302 also generates an internal transaction ID associated with the request and appends logging metadata for traceability and audit purposes.

For example, when client device(s) interface 302 receives a JWE-wrapped POST request containing an encrypted content hash and session metadata from orchestration server 120, it decrypts the payload, verifies field conformance, and extracts the content hash for lookup. If the hash is not present in the model version store 324, the interface proceeds with classification, routing the request to embedding generator 312 and appending transaction-level metadata such as user locale, plug-in version, and client IP address. If the hash is found and already mapped to a prior classification, client device(s) interface 302 may bypass redundant inference and return the stored result to orchestration server 120, optimizing throughput and latency in high-volume deployments.

Ingestion server interface 304 is operable to coordinate internal classification requests received from orchestration server 120 and expose structured service endpoints for invocation by other components within the system architecture. M ore specifically, ingestion server interface 304 provides a stable communication channel between orchestration server 120 and the processing layers of categorization engine 130. It interprets inbound classification requests, resolves routing parameters, and dispatches normalized representations to pre-processing module 310. In certain embodiments, ingestion server interface 304 also enforces access control policies, handles retry logic for transient failures, and manages protocol compliance for gRPC- or REST-based service integration.

For example, when orchestration server 120 submits a classification request containing a normalized content vector and content hash via gRPC, ingestion server interface 304 validates the input format, extracts request metadata, and routes the request to embedding generator 312. If the request includes an override parameter—such as a model version identifier or feedback-flag marker—the interface appends that information to the dispatch context. In some implementations, ingestion server interface 304 may also expose a logging hook or distributed tracing header that propagates transaction-level state to downstream components for observability or debugging purposes.

Persistent storage interface 306 is operable to transmit classification inputs and outputs between categorization engine 130 and persistent storage cluster 140. M ore specifically, persistent storage interface 306 serializes classification artifacts—including content hashes, competency predictions, depth-of-knowledge scores, confidence values, and associated metadata—and writes them to append-only queues or structured log partitions configured for model retraining, audit analysis, or longitudinal evaluation. The interface also accepts incoming retrieval requests from categorization engine 130 to support historical lookup, feedback aggregation, or deferred processing.

For example, when categorization engine 130 produces a new classification result from embedding generator 312 and label classifier 316, persistent storage interface 306 packages the output as a structured object that includes the original hash, classification tuple, model version identifier, and a timestamp. This object is written to a retraining queue within persistent storage cluster 140, tagged with routing context such as originating client device ID or plug-in version. In some embodiments, persistent storage interface 306 supports versioned writes with consistency guarantees—e.g., using optimistic concurrency tokens or write-ahead logs—to ensure traceability of feedback loops. When operating in audit mode, persistent storage interface 306 may expose read access to resolved classification records for a given hash or model ID, enabling downstream systems to perform validation or generate lineage reports.

Standards repository interface 308 is operable to retrieve domain-specific classification standards, including competency frameworks, depth-of-knowledge taxonomies, and versioned labeling schemas, for use during the classification process executed by categorization engine 130. M ore specifically, standards repository interface 308 queries an external or system-maintained knowledge base to obtain current tagging guidelines, structural mappings, and allowed label sets, enabling consistent alignment of classification outputs to an authoritative reference. The interface may perform periodic synchronization to update internal model parameters or remapping logic in response to schema revisions.

For example, when a new model version is initialized within label classifier 316, standards repository interface 308 may retrieve the active competency framework corresponding to a designated domain—such as middle school science or postsecondary engineering—and supply a machine-readable label hierarchy including canonical tag names, allowable depth-of-knowledge levels, and semantic groupings. In certain embodiments, standards repository interface 308 also retrieves remapping definitions that relate deprecated label sets to newer frameworks, enabling dynamic realignment during post-inference processing. The retrieved data may be cached locally or version-pinned for consistent operation across classification cycles, and may include metadata such as framework effective date, jurisdictional alignment, or taxonomy source authority.

Pre-processing module 310 is operable to transform a decrypted, normalized classification request into an embedding-ready representation suitable for downstream vectorization by embedding generator 312. M ore specifically, pre-processing module 310 performs structured text normalization, token sequence construction, and optional metadata augmentation on the incoming content derived from client device(s) interface 302. The output of pre-processing module 310 is a structured request object that encodes both content-derived linguistic features and contextual session metadata in a format conformant with the input requirements of the deployed embedding model.

In various embodiments, pre-processing module 310 applies a sequence of deterministic and learned routines to clean and standardize input content prior to embedding. Structured text normalization may include lowercasing, diacritic removal, punctuation stripping, and whitespace collapsing. For example, a raw input string such as “Identify the primary function of mitochondria?” may be normalized to “identify the primary function of mitochondria”, eliminating formatting artifacts while preserving semantic content. Learned routines may include domain-adaptive spelling correction or synonym normalization applied through lightweight transformer models trained on curriculum-aligned instructional text.

Token sequence construction may proceed via subword segmentation algorithms aligned to the configuration of embedding generator 312. For instance, the normalized input “photosynthetic process” may be segmented into {“photo”, “##synthetic”, “process”} using WordPiece, or into {“phot”, “osynthetic”, “process”} using byte-pair encoding (BPE), depending on the embedding model's vocabulary. The resulting tokens are stored as a positional sequence and passed downstream along with token type IDs, attention masks, and optional segment indicators.

In certain embodiments, pre-processing module 310 applies phrase grouping logic to detect multi-word expressions using statistical or rule-based chunking. For example, the phrase “order of operations” may be identified via a bigram frequency table or noun-phrase tagger, then marked as a compound token using an inline tag such as [MWE_START] . . . [MWE_END]. These annotations are preserved through embedding generation to allow joint representation. In another example, pre-processing module 310 may use named entity recognition to tag “Newton's laws” or “Lewis structure” as domain-specific concepts and assign embedding class weights accordingly.

Embedding generator 312 is operable to convert normalized token sequences and auxiliary metadata into fixed-dimensional vector representations suitable for classification by competency classifier 314. M ore specifically, embedding generator 312 applies a configured embedding model—such as a pre-trained transformer encoder or lightweight sentence encoder—to generate dense vector encodings of instructional content captured by pre-processing module 310. These encodings serve as semantic fingerprints of the learning-object item, supporting classification operations without requiring access to the original plaintext input.

In various embodiments, embedding generator 312 receives the output of pre-processing module 310, which may include tokenized sequences, attention masks, segment identifiers, and contextual metadata features. The embedding generator processes this structured input using a model architecture specified in the active model manifest. For example, if the configured model is a 12-layer transformer encoder trained on K-12 instructional materials, embedding generator 312 may compute contextual embeddings for each token position and derive a pooled embedding using the final-layer [CLS] token or a weighted average across token positions, depending on the pooling strategy.

In one implementation, embedding generator 312 supports model variants trained with contrastive learning objectives, enabling content hashes derived from semantically similar learning-object items to map to proximate regions in the embedding space. For instance, questions such as “What is the function of the mitochondria?” and “Describe the role of mitochondria in cells” may yield embeddings whose cosine similarity exceeds 0.95, allowing downstream components to generalize classification results across paraphrased content.

In certain embodiments, embedding generator 312 also incorporates side-channel features—such as curriculum tag hints, document type, or platform context—via embedding concatenation or adapter fusion layers. For example, if a taxonomy hint field specifies “Grade 8 Physical Science,” the embedding generator may apply a domain-specific adapter that projects token representations into a subspace tuned for middle school science competencies. These adapters are selected dynamically based on input metadata and model version.

Embedding outputs from embedding generator 312 are formatted as fixed-length floating-point vectors (e.g., 768- or 1024-dimensional) and passed to competency classifier 314 (e.g., a transformer-based model). The vectors may be accompanied by auxiliary projection metadata (e.g., embedding confidence score, dropout mask, or segment weight vectors), which are used to support interpretation, caching, or downstream refinement. In certain embodiments, embedding generator 312 logs model version, runtime latency, and input vector norm for each request, enabling performance auditing and system-level optimization.

Competency classifier 314 is operable to assign one or more competency labels and depth-of-knowledge levels to a learning-object item based on its vector representation generated by embedding generator 312. M ore specifically, competency classifier 314 applies a trained transformer-based classification model to the input embedding and outputs a structured classification response containing predicted competency identifiers, depth-of-knowledge designations, and associated confidence scores.

In various embodiments, competency classifier 314 includes a transformer encoder architecture configured for multi-label text classification. The classifier accepts fixed-length embeddings and projects them into a label space defined by the active competency framework stored in standards repository interface 308. The model parameters are trained using supervised examples annotated with known competency and depth-of-knowledge pairs, and may be fine-tuned periodically based on feedback stored in persistent storage interface 306.

For example, if the embedding vector corresponds to the instructional phrase “Explain the water cycle and its stages,” competency classifier 314 may assign the label Earth Systems: Water Cycle and depth-of-knowledge level Level 2-Skills and Concepts, along with a confidence score of 0.89. The classifier may also return a model version identifier and auxiliary outputs, such as token attention maps or classification logits, depending on the deployment configuration.

In certain embodiments, competency classifier 314 supports classification under multiple taxonomic frameworks simultaneously. For instance, the classifier may concurrently produce labels aligned with Common Core State Standards (CCSS), Next Generation Science Standards (NGSS), or a proprietary district-defined taxonomy. These outputs may be returned as separate key-value pairs or unified under a hierarchical schema depending on the needs of the downstream integration system.

Competency classifier 314 may also support label calibration and threshold tuning based on client-specific classification criteria. For example, a district may require a minimum confidence of 0.85 for automated tagging to be applied to student-facing content. In response, competency classifier 314 applies a post-inference filter to exclude predictions that fall below the configured threshold or re-rank candidate labels using a domain-specific weighting function.

Competency classifier 314 may also support label calibration and threshold tuning based on client-specific classification criteria. For example, a district may require a minimum confidence of 0.85 for automated tagging to be applied to student-facing content. In response, competency classifier 314 applies a post-inference filter to exclude predictions that fall below the configured threshold or re-rank candidate labels using a domain-specific weighting function.

Depth-of-knowledge classifier 316 is operable to assign a cognitive complexity level to a learning-object item based on its semantic embedding and associated processing context. M ore specifically, depth-of-knowledge classifier 316 evaluates the latent representation produced by embedding generator 312 and applies a dedicated classification routine—either standalone or integrated with competency classifier 314—to produce a depth-of-knowledge level, such as “Recall,” “Skills and Concepts,” or “Strategic Thinking.”

In various embodiments, depth-of-knowledge classifier 316 utilizes a multi-class prediction model trained on annotated instructional content spanning a range of subject areas and grade levels. The classifier may operate as a distinct module with its own model weights or as a branching output layer within a unified transformer-based classifier that shares lower-level representations with competency classifier 314.

For example, when the system processes an input item such as “Describe the role of mitochondria in cellular respiration,” depth-of-knowledge classifier 316 may assign a Level 1 (Recall) or Level 2 (Skills and Concepts) classification depending on how the prompt structure aligns with annotated examples. The model may leverage sentence structure, verb complexity, and domain-specific token context to disambiguate between adjacent levels.

In some implementations, depth-of-knowledge classifier 316 includes a calibration layer to tune the prediction outputs based on historical confidence intervals, user-submitted feedback, or externally imposed policy constraints. For example, classification confidence scores may be adjusted upward for prompts that include scaffolding terms commonly associated with instructional practice at higher cognitive levels.

In an embodiment, depth-of-knowledge classifier 316 outputs a predicted level identifier (e.g., “Level 3-Strategic Thinking”) along with an associated confidence score, model version ID, and optional rationale indicators (e.g., attention-weighted token influence or syntactic role attribution). These outputs are forwarded to orchestration server 120 and may be rendered inline by real-time UI renderer 220 or stored in persistent storage interface 306 for feedback analysis, retraining, or audit review.

Additionally, depth-of-knowledge classifier 316 may contribute to composite tagging strategies wherein multiple labels—competency, depth, and learning modality—are jointly evaluated for consistency and pedagogical alignment. This enables downstream validation or override logic when the system detects classification conflicts or low-confidence label combinations across taxonomies.

Confidence calculator 318 is operable to compute calibrated certainty scores for classification outputs generated by competency classifier 314 and depth-of-knowledge classifier 316. M ore specifically, confidence calculator 318 evaluates internal model logits, historical outcome variance, and contextual signal strength to generate a structured confidence metric for each label assigned during the inference process.

In various embodiments, confidence calculator 318 applies post-processing techniques to raw model predictions, such as temperature scaling, Platt scaling, or isotonic regression, to align raw softmax outputs with empirically observed accuracy. The resulting confidence scores may be expressed as bounded scalar values (e.g., 0.0-1.0) or categorized into tiers (e.g., “low,” “moderate,” “high”) depending on downstream consumption requirements.

For example, when competency classifier 314 assigns the label “Linear Functions” to an input prompt and depth-of-knowledge classifier 316 assigns “Level 2—Skills and Concepts,” confidence calculator 318 receives the corresponding logit vectors, computes the entropy of the probability distribution, and adjusts the raw scores based on a calibration map derived from prior performance on the same taxonomy. If the assignment falls within a high-confidence cluster, the final confidence score may exceed 0.90 and be tagged as suitable for auto-display without additional review.

In certain embodiments, confidence calculator 318 also incorporates auxiliary metadata—such as prompt length, syntactic complexity, or frequency of prior user corrections—to further refine its output. This allows the system to down-weight overconfident predictions on ambiguous or previously disputed items, thereby improving reliability in instructional contexts.

Additionally, confidence calculator 318 may emit traceable metadata with each output, including the calibration strategy used, model version reference, and contributing feature weights, supporting auditability and structured logging in persistent storage interface 306. These metrics can be used for threshold-based rendering by real-time UI renderer 220 or to trigger quality-control workflows when confidence scores fall below a defined operational floor.

Feedback weighting module 320 is operable to receive, interpret, and assign weighted influence to user-supplied feedback records during model retraining workflows. M ore specifically, feedback weighting module 320 consumes interaction data collected by feedback capture interface 222—such as accept/reject signals or revised label submissions—and computes priority scores that guide inclusion of the feedback examples in future model updates managed by retraining scheduler 322.

In various embodiments, feedback weighting module 320 applies dynamic scoring routines that take into account several contextual inputs, including: (i) frequency of similar feedback for a given label or item class, (ii) confidence score of the original prediction, (iii) time elapsed since model deployment, and (iv) whether the feedback was an explicit override or a passive confirmation. The computed weights serve as coefficients during loss reweighting or data sampling in fine-tuning cycles, thereby amplifying high-signal corrections while suppressing noisy or redundant entries.

For example, when multiple users reject the tag “Algebraic Reasoning” for the same Content hash and instead supply “Quantitative Relationships,” feedback weighting module 320 aggregates the corrections, detects the common override pattern, and assigns an elevated weight to the corrected example. If the original prediction had a confidence score above 0.85, the module may further elevate the priority due to the high-impact nature of the misclassification.

In certain embodiments, feedback weighting module 320 includes a decay function that down-weights older feedback unless confirmed by recurrence, as well as a normalization layer that caps influence from any single client session to prevent localized skew. Feedback weights are formatted into structured records that include content hash, original and corrected label(s), timestamp, user action type, and calculated weight value, then forwarded to retraining scheduler 322 via persistent storage interface 306.

This structured weighting approach enables categorization engine 130 to adapt its inference behavior over time while preserving traceability, reproducibility, and protection against feedback loops that could degrade model generalization.

Retraining scheduler 322 is operable to coordinate the periodic execution of model retraining workflows using curated and weighted feedback data. M ore specifically, retraining scheduler 322 orchestrates the ingestion of correction records from persistent storage interface 306, invokes feedback weighting module 320 to compute inclusion scores, and triggers fine-tuning procedures on categorization engine 130 using the selected dataset.

In various embodiments, retraining scheduler 322 operates on a configurable cadence (e.g., nightly, weekly, or on-demand) and supports both full and incremental retraining modes. The scheduler may evaluate factors such as feedback volume thresholds, model drift indicators, or time since last deployment to determine whether a retraining cycle should be initiated. When activated, retraining scheduler 322 assembles a training dataset consisting of prior classification inputs, corresponding ground-truth labels derived from user corrections, and associated confidence metadata.

For example, when feedback capture interface 222 accumulates a sufficient number of overrides indicating consistent misclassification for a particular topic (e.g., “Microbial Genetics” repeatedly misclassified as “Molecular Biology”), retraining scheduler 322 identifies the affected concept space, pulls relevant examples from persistent storage cluster 140, and compiles a reweighting map using output from feedback weighting module 320. The resulting dataset is passed to a model fine-tuning pipeline with epoch controls, learning rate schedules, and early stopping configured according to model performance metrics.

In certain embodiments, retraining scheduler 322 also supports shadow deployments, wherein updated model variants are evaluated in parallel against live inference traffic to compute performance deltas before committing to production rollout. The scheduler tracks model version identifiers, retraining parameters, and evaluation outcomes, and logs this metadata to model version store 324 for audit and reproducibility.

By decoupling model adaptation from front-line inference operations, retraining scheduler 322 enables categorization engine 130 to evolve in response to real-world user behavior while preserving deployment stability and minimizing inference latency during model updates.

Model version store 324 is operable to persist and manage multiple deployed and historical versions of the machine learning models used by categorization engine 130. M ore specifically, model version store 324 stores versioned model artifacts—such as weight checkpoints, configuration parameters, and associated metadata—and provides structured access to enable real-time inference, validation replay, or retraining lineage tracking.

In various embodiments, model version store 324 supports immutable versioning of classification models, including those used by competency classifier 314 and depth-of-knowledge classifier 316. Each version may be associated with a unique identifier, training timestamp, originating retraining job, evaluation scores, and configuration context (e.g., embedding dimensionality, tokenizer type, and blueprint mapping).

For example, when retraining scheduler 322 initiates a model update based on newly weighted feedback samples, the resulting fine-tuned model is serialized and stored in model version store 324 with metadata such as validation F1-score, learning rate schedule, and the specific feedback weighting parameters applied. The store maintains atomic consistency during writes, ensuring that no partially trained or malformed model artifact is ever promoted to production.

In certain embodiments, model version store 324 supports real-time model selection logic, enabling categorization engine 130 to dynamically load and execute a specific version of a model based on contextual criteria-such as document type, client identifier, or plug-in version. This capability allows for A/B testing of classification behavior, targeted rollback in response to anomaly detection, or tiered model assignment across user cohorts.

Additionally, model version store 324 supports lineage tracking and auditability. For any classification response served to plug-in 114, orchestration server 120 may include the corresponding model version identifier in the response payload, enabling traceability of predictions back to the exact model state in use. This design ensures both compliance with audit requirements and reproducibility of inference behavior under variable deployment conditions.

Framework mapping engine 326 is operable to align classification outputs produced by categorization engine 130 with one or more competency frameworks, taxonomies, or schema representations used by downstream systems. M ore specifically, framework mapping engine 326 receives predicted competency labels and depth-of-knowledge values and translates these outputs into standardized framework-aligned identifiers that correspond to institutional or jurisdictional alignment requirements.

In various embodiments, framework mapping engine 326 accesses a repository of mapping configurations that define equivalence classes, hierarchical associations, and alias sets between model-predicted labels and the canonical identifiers used by educational standards frameworks. Mapping logic may include both direct lookup and rule-based inference, supporting one-to-one, one-to-many, and hierarchical remapping relationships.

For example, when competency classifier 314 produces a label such as “Cellular Respiration-Mitochondria,” framework mapping engine 326 may determine that this maps to canonical framework identifier “SC.912.L.18.9” under a given state-level science standard. In cases where multiple candidate mappings exist—for example, due to overlapping descriptors or grade band ambiguity—the engine applies disambiguation rules based on plug-in context, user role, or course metadata.

In certain embodiments, framework mapping engine 326 supports dynamic remapping routines in response to framework updates. When a new version of a competency framework is introduced, the engine is operable to apply remapping logic that aligns legacy classification outputs to the updated framework. These remapping routines may include gap detection (e.g., identifying unmapped labels), forward compatibility analysis, and continuity tagging to flag records that span multiple framework versions.

Framework mapping engine 326 also records the applied mapping for each classification response, enabling downstream systems to perform validation, reporting, and analytics in a framework-consistent manner. For example, persistent storage cluster 140 may store both the raw model prediction and its mapped framework identifier, allowing analytics queries to operate over either representation depending on context.

In accordance with various embodiments, the output of categorization engine 130 comprises a structured classification payload that includes one or more predicted competency tags, an associated depth-of-knowledge designation, a confidence score, and optionally, a model version identifier and framework mapping metadata. The competency tag is selected from a predefined or dynamically extensible taxonomy and reflects the inferred subject domain or learning objective associated with the input content. The depth-of-knowledge designation is derived from a calibrated classifier and encodes a level of cognitive demand (e.g., recall, application, synthesis) based on the underlying model configuration. The confidence score represents a probabilistic estimate of classification reliability and may be expressed as a normalized floating-point value. The model version identifier is linked to the model version record retrieved from model version store 324, enabling downstream auditability. In certain embodiments, framework mapping engine 326 appends additional metadata to the output to indicate crosswalk alignment with one or more external standards frameworks, supporting interoperability and downstream integration. The output payload is transmitted to orchestration server 120 for encryption, delivery, and optional UI injection by plug-in 114 on client computing device(s) 110.

In various embodiments, the structured classification payload may be transmitted over network 150 to orchestration server 120 for immediate encryption and delivery to plug-in 114 on client computing device(s) 110. Alternatively, or in addition, the payload may be written to persistent storage cluster 140 for archival, audit, or asynchronous consumption by downstream systems. In some configurations, the output may be incorporated into an append-only event stream or stored in a versioned results database to support retrospective analysis, training data expansion, or curriculum alignment reporting. The structured format of the output enables integration with third-party systems via standardized A Pls and facilitates interoperability across learning management systems, analytics dashboards, or compliance reporting tools. Each output instance may be accompanied by metadata indicating the processing timestamp, model lineage, and session context, ensuring traceability and supporting validation across distributed deployments.

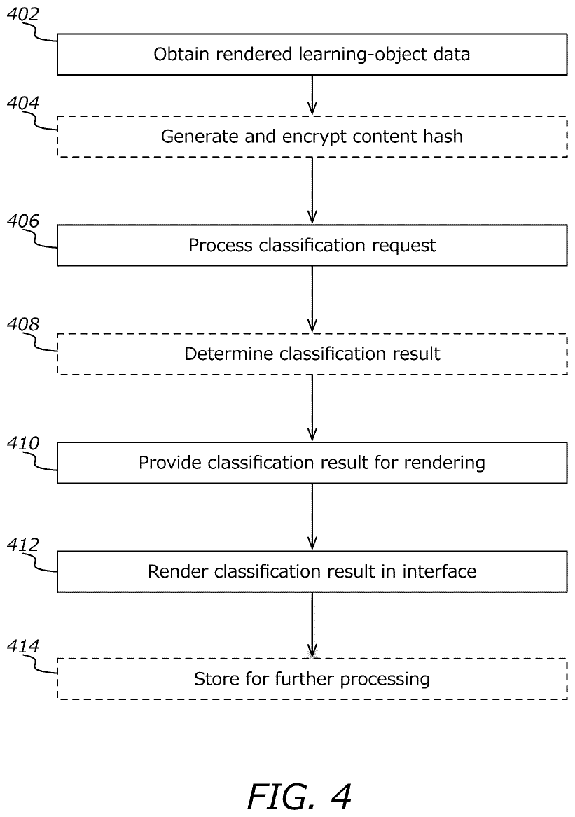

FIG. 4 illustrates an example for classifying learning-object content and providing encrypted classification results, in accordance with various embodiments. The steps represent operations executed by components described in FIG. 1, FIG. 2, and FIG. 3, including plug-in 114, orchestration server 120, categorization engine 130, and persistent storage cluster 140. The process includes structured detection, secure transmission, classification, interface rendering, and storage of classification records for further processing. The process may include additional steps, fewer steps, or steps in a different order, as would be apparent to one of ordinary skill in the art.

At step 402, obtain rendered learning-object data. In various embodiments, rendered learning-object data includes instructional elements such as assessment questions, course objectives, or competency-aligned prompts that are presented to a user within a digital interface. This content may appear as part of an interactive learning module, embedded quiz, or standards-based instructional flow delivered through a web browser, native application, or embedded system interface. The system detects rendered content by monitoring the active user interface for document object model (DOM) updates, layout mutations, or render-complete signals that indicate a new instructional item has been displayed. In some embodiments, visibility thresholds or intersection-based triggers are used to determine whether the learning-object content has been fully rendered and is eligible for downstream classification. Once detected, the content is extracted in textual or structured form and prepared for secure hashing and metadata tagging.

At step 404, generate and encrypt a content hash. In various embodiments, the system normalizes the extracted learning-object content-removing markup, excess whitespace, and formatting artifacts-prior to computing a fixed-length, non-reversible cryptographic hash (e.g., using SHA-256). The resulting hash value is combined with session-level metadata, such as a timestamp, content identifier, and an initialization vector. This data is assembled into a structured payload and encrypted using either a symmetric or asymmetric encryption scheme, depending on system configuration. The encrypted payload is formatted as a JSON Web Encryption (JWE) object suitable for transmission and validation by downstream components. In certain implementations, payload generation may also include client-side indicators such as plug-in version, language locale, or originating IP address to support auditability and classification context.

At step 406, process classification request. In various embodiments, the system receives an encrypted classification request containing a cryptographic hash of the learning-object content and associated session metadata. The classification request may include a structured payload formatted as a JSON Web Encryption (JWE) object, which encapsulates values such as the hashed representation of the content, a timestamp, an initialization vector, and session-specific context (e.g., IP address, client plug-in version, locale). The request is received by the system via a network 150 interface exposed by orchestration server 120 and is decrypted using a server-managed private key.

Once decrypted, the system performs schema validation to confirm the presence and integrity of expected fields and may associate the request with a transaction ID for traceability. In certain embodiments, the system consults a local or distributed classification cache to determine whether the content hash has previously been classified. If a match is found, the cached classification is returned, bypassing downstream inference. If not, the system forwards the normalized request to categorization engine 130 for classification, as described in step 408. The validated request is appended to an internal message queue for audit logging, retraining input, or asynchronous retry in the event of transient processing errors.

At step 408, determine classification result. In various embodiments, the system determines one or more classification outputs for the submitted learning-object hash by invoking categorization engine 130. The input to this step is the normalized request derived from step 406, which includes a non-reversible cryptographic hash of the learning-object content and associated session metadata. The system forwards this input to categorization engine 130, which resolves the current model version from model version store 324 and uses embedding generator 312 to produce a latent vector representation of the learning-object content corresponding to the submitted hash.

The resulting vector is then classified using one or more trained inference models. For example, competency classifier 314 assigns one or more standardized competency labels to the content, while depth-of-knowledge classifier 316 predicts the cognitive complexity level associated with the material. Confidence calculator 318 computes confidence metrics for each predicted label. In certain embodiments, feedback weighting module 320 adjusts model outputs based on prior user-supplied feedback, and the full set of classification results is appended to an internal record tagged with the applicable model version identifier and timestamp. The resulting classification response is then returned to orchestration server 120 for downstream delivery.

At step 410, provide classification result for rendering. In various embodiments, the system prepares the classification output determined in step 408 for use by the client computing environment, including formatting and encrypting the result for delivery to plug-in 114. The classification result includes structured metadata such as competency labels, depth-of-knowledge scores, confidence values, and optionally a model version identifier or timestamp. This structured output is converted into a response payload and encrypted using the client session key previously established during plug-in initialization.

The encrypted payload is then transmitted from orchestration server 120 over network 150 and received by ingestion server interface 218. Upon receipt, the payload is passed to real-time UI renderer 220, which is operable to identify the corresponding content region on the screen and inject the classification metadata into the user interface without altering the original learning-object content. In certain embodiments, the response also includes additional rendering context such as styling hints, display preferences, or metadata confidence thresholds that determine how or when the classification should be presented.

In certain embodiments, the encryption of the classification result may be performed using a symmetric encryption scheme, such as AES-GCM, in combination with a session-specific client key derived during plug-in initialization. This approach enables low-latency payload construction on the client side and supports replay protection by pairing each encryption operation with a unique initialization vector and client session token. Although other encryption strategies may be used, symmetric session-level encryption offers performance advantages in environments with constrained compute or mobile device deployments.

At step 412, render classification result in interface. In various embodiments, the system presents the received classification metadata to the user within the context of the original learning-object content. This rendering is performed by real-time UI renderer 220, which receives the structured classification response and associates it with the corresponding user interface element previously identified by plug-in 114 during the content observation and hashing process.

The rendering logic may include injecting visible annotations adjacent to or within the displayed content region, such as overlay labels indicating competency type, a depth-of-knowledge score, or a visual confidence indicator (e.g., a bar or badge). The renderer may apply styling logic based on configuration flags—such as color coding by competency domain or collapsing low-confidence results—to ensure readability and non-disruptive integration with the host learning application. In certain embodiments, accessibility metadata (e.g., aria-labels) is appended to the rendered elements to support screen readers and compliant interface behavior. Rendering may occur asynchronously to preserve performance and may trigger event notifications to other plug-in components, such as feedback capture interface 222.

At step 414, store for further processing. In various embodiments, the system persists the classification interaction for downstream use in retraining workflows, audit traceability, or deferred validation. Upon successful rendering of the classification metadata in step 412, plug-in 114 generates a structured record that includes the original content hash, the classification response, associated metadata such as confidence score and timestamp, and optionally, user interaction indicators (e.g., whether the user accepted, dismissed, or modified the label).

This structured record is encrypted and transmitted via ingestion server interface 218 to orchestration server 120, which appends the record to a message queue maintained in persistent storage cluster 140. The queue is used by retraining scheduler 322 and related components within categorization engine 130 to refine classification models during scheduled updates. In certain embodiments, the stored record may also be tagged with indicators such as model version, plugin configuration, or client deployment ID, allowing the system to trace classification behavior across environments and incorporate contextual weightings into subsequent training data generation.

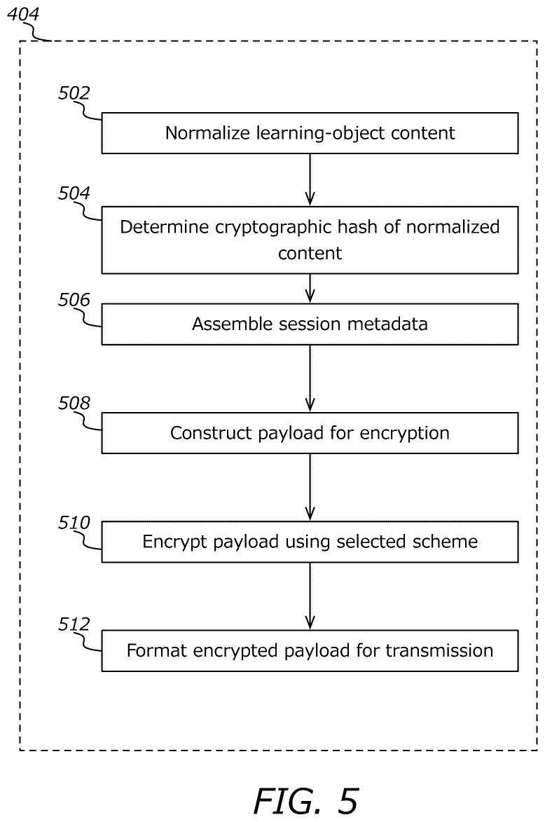

FIG. 5 illustrates an example process for generating and encrypting a content hash derived from rendered learning-object content, in accordance with various embodiments. The process corresponds to step 404 of FIG. 4 and represents operations performed by plug-in 114 within client computing device(s) 110, as described in FIG. 1 and FIG. 2. The steps include normalization of rendered content, determination of a cryptographic hash, metadata construction, and encryption of the assembled payload into a secure classification request. The process may include additional steps, fewer steps, or steps in a different order, as would be apparent to one of ordinary skill in the art.

At step 502, normalize learning-object content. In various embodiments, the system receives a textual or structured representation of a rendered learning-object item, such as an assessment question or instructional prompt. The system performs normalization operations to remove extraneous formatting-such as HTML tags, whitespace, or embedded layout artifacts-resulting in a consistent, semantically meaningful string. In certain implementations, the system applies Unicode normalization, converts to lowercase, and removes stop words or markup characters. The resulting output is a clean text representation suitable for downstream hashing and classification.

At step 504, determine cryptographic hash of normalized content. In various embodiments, the system applies a non-reversible cryptographic function, such as SHA-256, to the normalized learning-object content produced in step 502. The hash function maps the input string to a fixed-length binary value that uniquely represents the content. This hash value serves as a content identifier throughout the classification process and is designed to be collision-resistant and deterministic. The hash output is stored in memory and used in subsequent payload construction.

At step 506, assemble session metadata. In various embodiments, the system generates a metadata bundle associated with the content hash determined in step 504. The metadata may include a timestamp corresponding to the moment of rendering or capture, a content identifier, a client-generated initialization vector, and additional contextual values such as plug-in version, user locale, and originating IP address. This metadata is organized into a key-value structure that aligns with the system's internal payload schema and supports traceability, authentication, and classification context.

At step 508, construct payload for encryption. In various embodiments, the system combines the content hash from step 504 and the session metadata from step 506 into a structured data object. This object may be defined using a schema that ensures consistent ordering and presence of required fields, such as {hash, timestamp, iv, client_info}. In certain implementations, the structure may be serialized into a JSON-compatible format and include diagnostic or routing headers to support transmission handling. The constructed object is prepared as the input to the encryption logic in step 510.

At step 510, encrypt payload using selected scheme. In various embodiments, the structured payload assembled in step 508 is encrypted using a cryptographic scheme appropriate to the system's configuration. This may include symmetric encryption (e.g., AES-GCM) using a shared client-server key, or asymmetric encryption (e.g., RSA) using the public key of orchestration server 120. The encryption process transforms the plaintext payload into an opaque, tamper-resistant binary or base64-encoded token. The output conforms to a format such as JSON Web Encryption (JWE) and is not decryptable without possession of the corresponding decryption key.

At step 512, format encrypted payload for transmission. In various embodiments, the encrypted token produced in step 510 is embedded into a transport structure compatible with the system's classification request protocol. For example, the token may be inserted into the body of an HTTPS POST request targeting a classification endpoint exposed by orchestration server 120. The request may also include headers specifying content type, plug-in version, and encryption scheme. The final output is a transmission-ready payload suitable for delivery over network 150.

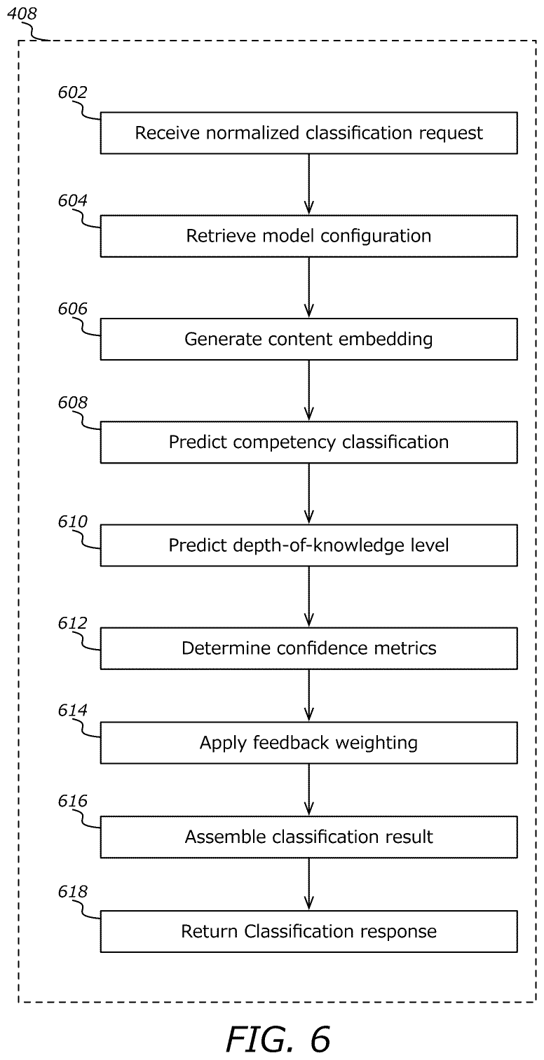

FIG. 6 illustrates an example process for determining a classification result for rendered learning-object content, in accordance with various embodiments. The steps represent operations performed by categorization engine 130 and related components described in FIG. 1 and FIG. 3, including embedding generator 312, competency classifier 314, depth-of-knowledge classifier 316, confidence calculator 318, feedback weighting module 320, and model version store 324. The process transforms a normalized classification request into structured competency metadata by generating vector representations, applying trained inference models, computing confidence scores, and optionally incorporating user feedback. The process may include additional steps, fewer steps, or steps executed in a different order, as would be apparent to one of ordinary skill in the art.

At step 602, receive normalized classification request. In various embodiments, the system receives a structured input representing a previously rendered learning-object item. The classification request includes a non-reversible cryptographic hash derived from normalized content, as described in FIG. 5, along with session metadata such as a timestamp, plug-in identifier, and optional locale or device attributes. This input may be decrypted and schema-validated by orchestration server 120 prior to transmission into categorization engine 130.

The request is formatted in a canonical internal representation and includes references to content identifiers and routing information used to associate the incoming request with a current model version or processing queue. In some embodiments, the classification request may also contain feedback-derived annotations from prior interactions or system-generated context tags. The structured request is passed to embedding generator 312 for downstream processing in step 604.

At step 604, retrieve model configuration. In various embodiments, the system determines the active classification configuration by retrieving a current model version identifier and associated parameters from model version store 324. The configuration includes model architecture references, embedding dimensionality requirements, and classification thresholds used by competency classifier 314, depth-of-knowledge classifier 316, and confidence calculator 318.

The system may also retrieve auxiliary parameters such as feedback weighting coefficients, feature normalization settings, or domain-specific override rules, depending on the operational context. In certain embodiments, model version store 324 maintains a versioned registry of model checkpoints and schema bindings, allowing categorization engine 130 to resolve which classification models and supporting components to invoke for the incoming request. The retrieved configuration is then made available to embedding generator 312 and subsequent modules for use in the processing steps that follow.

At step 606, generate content embedding. In various embodiments, the system determines a latent vector representation of the learning-object content associated with the received classification request. The system uses embedding generator 312 to transform the normalized content into an embedding compatible with the current model configuration retrieved in step 604.

More specifically, embedding generator 312 retrieves the input content associated with the cryptographic hash-either directly or by mapping to a local representation cache and tokenizes the content using a subword encoding scheme such as byte-pair encoding (BPE) or WordPiece. The tokenized content is passed through a trained transformer-based embedding model, which produces a fixed-length vector encoding semantic and syntactic features of the input. In certain embodiments, embedding generator 312 applies additional positional encoding, phrase-group detection, or attention masking to enhance contextual sensitivity. The resulting embedding is formatted for consumption by the classification modules in step 608 and may be annotated with auxiliary metadata such as token sequence length, vocabulary version, or encoder checkpoint ID. For instance, when using a domain-tuned WordPiece vocabulary (v5.4), the system appends the vocabulary version to the embedding metadata.

For example, when the normalized content includes the sentence “Explain how photosynthesis converts solar energy into chemical energy,” embedding generator 312 tokenizes the input using WordPiece, resulting in the sequence [“Explain”, “how”, “photo”, “##synthesis”, “converts”, “solar”, “energy”, “into”, “chemical”, “energy”]. These tokens are passed to a transformer-based encoder trained on science-domain instructional content. The encoder produces a 768-dimensional vector embedding that captures semantic relationships relevant to the grade level and topic. This vector is passed forward to competency classifier 314 to support multi-label prediction against a standards-aligned science taxonomy.

At step 608, predict competency classification. In various embodiments, the system determines one or more competency classifications associated with the vectorized representation of the learning-object content. This classification is performed using one or more inference models associated with competency classifier 314. Each inference model is configured to accept an input embedding generated in step 606 and output a set of predicted competency labels aligned to a defined taxonomy of instructional standards.

In certain embodiments, competency classifier 314 includes a transformer-based multi-label classifier trained using binary cross-entropy loss. The model accepts a fixed-length embedding vector (e.g., 768 dimensions) as input and produces a multi-hot label vector across N competency classes (e.g., Next Generation Science Standards, Common Core Mathematics, or custom organizational taxonomies). Training data may include millions of annotated learning-object samples labeled by domain experts or derived from standards-aligned repositories, with sampling stratified across content type, grade level, and subject domain. The model may also incorporate dropout regularization, attention masking, or domain-specific encoder conditioning during inference. In certain embodiments, the classifier supports confidence-weighted output, wherein each predicted label is associated with a probability score representing classification certainty. The resulting classification predictions are passed to downstream components, such as depth-of-knowledge classifier 316 in step 610.

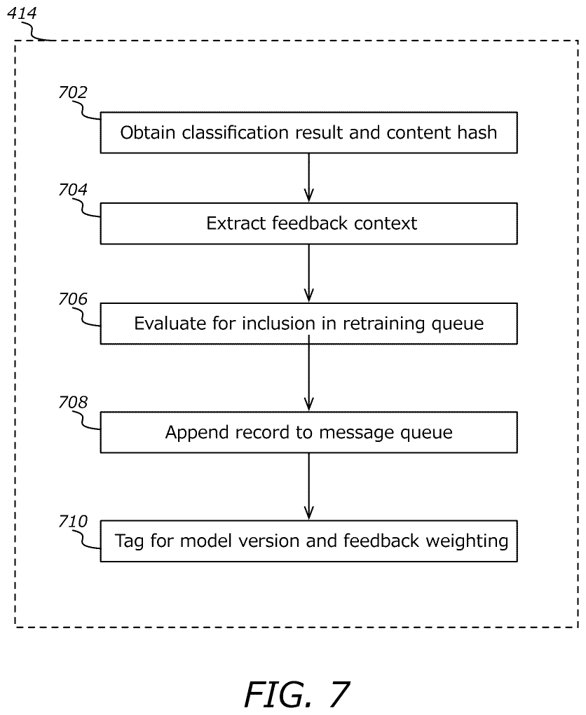

In various embodiments, the classification result determined in step 608 includes multiple structured outputs, each representing a distinct interpretive dimension of the learning-object content. A competency label refers to a machine-generated identifier that maps the normalized content to a domain-specific educational concept, skill, or standard, such as “Photosynthesis,” “Linear Equations,” or “Punctuation Usage-Level 3.” A depth-of-knowledge indicator refers to a scalar or categorical value that reflects the cognitive complexity associated with the content, typically aligned with pedagogical taxonomies such as Level 1: Recall, Level 2: Skill/Concept, Level 3: Strategic Thinking, or Level 4: Extended Thinking. A confidence metric refers to a numerical value that quantifies the system's certainty in the assigned label and depth-of-knowledge indicator, typically computed from softmax probability distributions or margin-of-separation scores produced by the inference models. For example, when categorization engine 130 classifies a normalized prompt relating to scientific notation, the resulting output may include a competency label of “Exponents and Scientific Notation,” a depth-of-knowledge indicator of “Level 2,” and a confidence metric of 0.88. These structured values are used by downstream components to determine display behavior, enable feedback capture, or queue the interaction for model retraining, as described in FIG. 4 and FIG. 7.

At step 610, predict depth-of-knowledge level. In various embodiments, the system evaluates the learning-object embedding generated in step 606 to determine a depth-of-knowledge (DOK) classification that characterizes the cognitive complexity of the instructional content. The system applies a trained inference model associated with depth-of-knowledge classifier 316 to perform this classification.

More specifically, the DOK inference model receives the embedding and computes one or more DOK level predictions (e.g., Level 1 through Level 4) based on latent feature activations learned from previously labeled instructional data. The model may implement a multi-class classification architecture—such as a softmax output layer on top of a dense representation—or a hierarchical structure to resolve fine-grained distinctions between closely related cognitive levels. In certain embodiments, the DOK classifier incorporates auxiliary features such as input sequence length, detected question stems (e.g., “analyze,” “evaluate”), or syntactic complexity scores derived from the original content to refine prediction accuracy.

For example, when processing the embedding corresponding to the content “Evaluate competing explanations for increases in global temperatures,” depth-of-knowledge classifier 316 identifies lexical indicators such as “evaluate” and “competing explanations,” which are strongly associated with DOK Level 3 or 4 tasks. The classifier computes probability scores across available DOK classes and returns the label “Level 3-Strategic Thinking” with a confidence of 0.88. This result is included in the classification output alongside competency labels predicted in step 608. The system may tag the result with model metadata such as DOK version, vocabulary profile, or relevant confidence thresholds used during inference.

At step 612, determine confidence metrics. In various embodiments, the system computes quantitative confidence scores associated with the classification outputs generated in steps 608 and 610. These metrics indicate the system's certainty in the predicted competency labels and depth-of-knowledge classifications and are used to support downstream rendering decisions, auditability, and retraining input.

More specifically, confidence calculator 318 receives the output logits or class probability vectors from each classification module and computes scalar confidence values using probabilistic or ensemble-based methods. In some embodiments, confidence calculator 318 applies a maximum softmax probability thresholding approach, while in others it may use temperature-scaled calibration or dropout-based Monte Carlo sampling to estimate uncertainty across prediction classes. The confidence values are rounded or bounded to ensure compatibility with rendering thresholds defined by real-time UI renderer 220.

For example, when competency classifier 314 assigns the label “Photosynthesis-NGSS.PS3.3” with a probability vector of [0.02, 0.06, 0.91, 0.01], confidence calculator 318 identifies the maximum class probability (0.91) as the associated confidence score. In another instance, if multiple inference models are used in an ensemble configuration, the calculator averages the predicted probabilities across models, adjusts using a temperature-scaling parameter (e.g., τ=1.2), and applies entropy-based measures to compute a calibrated confidence score.

In certain embodiments, confidence calculator 318 attaches metadata fields to each classification result—such as prediction entropy, score variance, or calibration version ID—to support downstream audit, visualization, or confidence-based rendering behavior. These confidence scores and annotations are combined with the classification output and passed forward for formatting and encryption in step 614.

At step 614, apply feedback weighting. In various embodiments, the system adjusts classification outputs based on previously received feedback data to bias or calibrate results in favor of user-confirmed corrections. This step enables the integration of explicit end-user signals into the inference workflow without requiring full retraining of the classification models.

More specifically, feedback weighting module 320 retrieves historical feedback records corresponding to the submitted content hash or a semantically similar content cluster. These feedback records, which are stored in persistent storage cluster 140 and indexed by cryptographic hash or embedding similarity, include user corrections, confirmations, or overrides captured through feedback capture interface 222. Each record may be associated with metadata such as session ID, timestamp, prior classification, user-selected label, and confidence score at time of submission.

In one implementation, feedback weighting module 320 maintains a feedback cache or priority map, which assigns amplification weights to classes based on frequency or recency of user corrections. For example, if a content hash previously classified as “Plant Cell Anatomy” was overridden multiple times by users selecting “Photosynthesis-NGSS.PS3.3,” the module increases the influence of the override class when the same or similar hash is encountered in future requests. In certain embodiments, feedback weighting module 320 applies a weight-scaling factor to the model output logits (e.g., multiplying the corrected class score by a factor of 1.25), followed by re-normalization to preserve valid probability distributions.

In other embodiments, the module uses embedding similarity to identify nearby content vectors and aggregates feedback-linked adjustment factors. For instance, if three related items—determined via cosine similarity above 0.85—have user-tagged corrections favoring a specific class, the feedback weighting module increases the base class confidence by a delta function proportional to the similarity-weighted correction count. These adjustments are performed in real-time and logged alongside the classification record to maintain auditability and traceability of the altered inference path.

the adjusted outputs are passed forward as part of the final classification response and may be tagged with feedback weighting metadata (e.g., “override_applied”: true, “adjustment_factor”: 1.25) to inform rendering decisions and retraining pipeline behavior in subsequent processing stages.

At step 616, assemble classification result. In various embodiments, the system constructs a structured response object that includes the outputs generated in steps 608 through 614. The response may include a primary competency label, a depth-of-knowledge designation, and associated confidence metrics. In certain embodiments, the response is further annotated with auxiliary fields such as model version identifiers, processing timestamps, session-level metadata, or plugin configuration markers.

More specifically, the response object is assembled into a format suitable for downstream consumption by plug-in 114 and archival by persistent storage cluster 140. The format may conform to an internal classification schema supporting traceability and rendering consistency. In one embodiment, the output includes a structured payload comprising fields such as a competency label (e.g., “NGSS.PS3.3”), a depth-of-knowledge level (e.g., “Level 2”), and a confidence score (e.g., 0.87). The output may also include model version information, optional alternate candidate labels, and metadata used for audit, filtering, or display control. The result is then returned to orchestration server 120 for encryption and delivery, as described in FIG. 4.

At step 618, return classification response. In various embodiments, the system transmits the structured classification result—assembled in step 616—from categorization engine 130 to orchestration server 120 for downstream delivery. The classification response includes machine-generated outputs such as competency labels, depth-of-knowledge predictions, associated confidence metrics, and model version identifiers, all structured in a format compatible with the receiving orchestration pipeline.

The response may be transmitted over network 150 using a structured messaging protocol, such as gRPC or HTTPS with JSON payloads, depending on system configuration. In some embodiments, the system appends response metadata to support traceability, including the model checkpoint ID, classification timestamp, and a request identifier linked to the original content hash. The system may apply outbound encryption or signing to ensure the integrity and authenticity of the returned classification data. This step completes the inference workflow and enables orchestration server 120 to route the result to plug-in 114 for rendering, as described in FIG. 4.

FIG. 7 illustrates an example process for recording classification outcomes and storing structured records for model retraining, in accordance with various embodiments. The steps represent operations performed by components such as plug-in 114, orchestration server 120, categorization engine 130, and persistent storage cluster 140, as introduced in FIG. 1 and further described in FIG. 2 and FIG. 3. This process corresponds to step 414 of FIG. 4 and includes collecting user interaction data, evaluating the classification context, and storing metadata-enriched records for use in scheduled retraining workflows. The process may include additional steps, fewer steps, or steps executed in a different order, as would be apparent to one of ordinary skill in the art.

At step 702, obtain classification result and content hash. In various embodiments, the system receives a completed classification response and the associated content hash from prior processing stages. The classification result may include a competency label, depth-of-knowledge designation, confidence score, and model version identifier generated in steps 608-616 of FIG. 6. The content hash is a non-reversible cryptographic representation of the rendered learning-object content, previously generated in step 404 of FIG. 4 and propagated through the classification pipeline.

The classification result and content hash are assembled into a structured record by plug-in 114, which may also include metadata such as session timestamp, plug-in version, and client locale. This record serves as the basis for downstream feedback evaluation and retraining eligibility determination. In certain embodiments, the classification result is retrieved from a message queue maintained by orchestration server 120 or directly received from the categorization engine 130 in response to a classification request. The system associates the classification result with the originating content instance by linking the content hash to the display event recorded in the session.

At step 704, extract feedback context. In various embodiments, the system extracts interaction-level metadata associated with the classification response rendered to the user. This feedback context may include explicit user actions—such as acceptance, rejection, or modification of the predicted label—as well as implicit behavioral signals, such as dwell time, focus events, or repeated interactions with a rendered classification.

More specifically, plug-in 114 captures the context surrounding the user's engagement with the classification result presented in step 412 of FIG. 4. For example, if the user clicks an “Edit” button to override a displayed competency label, the system records both the original prediction and the updated user-provided value. If the user hovers over the classification annotation for more than a defined duration (e.g., 3 seconds), the event may be interpreted as an attention signal and logged accordingly. In some embodiments, the feedback capture interface 222 attaches structured metadata to each recorded action, including element path, interaction type, timestamp, and display state at the time of interaction.

The feedback context may also include environmental or session-level variables that influence classification perception, such as the user's role (e.g., instructor or student), screen resolution, or latency between classification rendering and interaction. These variables are extracted and included in the downstream record to provide contextual grounding for retraining logic and anomaly evaluation. The output of step 704 is a structured feedback bundle linked to the corresponding classification result and content hash.

At step 706, evaluate for inclusion in retraining queue. In various embodiments, the system determines whether the extracted feedback context from step 704 should be persisted as a labeled training example for use in subsequent model updates. This evaluation is performed using a rule-based or heuristic module operating within orchestration server 120 or categorization engine 130.

More specifically, the system applies configurable criteria to determine whether the user feedback reflects a high-confidence correction or informative edge case suitable for retraining. For example, if the user overrides the predicted competency label and the session metadata indicates high interaction fidelity (e.g., non-trivial dwell time, no navigation anomalies, confidence score below threshold), the system tags the record as eligible. Conversely, if the interaction lacks sufficient evidence of corrective intent—such as transient cursor focus or rapid dismissals—the record may be excluded.

In certain embodiments, the evaluation includes comparison between the original and revised labels to assess semantic distance. For example, if the original classification is “Photosynthesis-Level 2” and the user revises it to “Plant Metabolism-Level 3,” the system computes a vector similarity score between the two labels using blueprint-constrained label embeddings. If the distance exceeds a configured retraining threshold, the record is prioritized as a high-value correction.

The output of step 706 is a decision flag—such as include_for_retraining=true—which is appended to the structured feedback bundle. This flag governs whether the feedback object proceeds to step 708 or is discarded or archived for audit purposes.

At step 708, append record to message queue. In various embodiments, the system writes the structured feedback object—containing the original content hash, classification metadata, user-provided correction (if applicable), and evaluation outcome from step 706—to a persistent message queue maintained in persistent storage cluster 140. The queue is operable to store feedback records designated for use in downstream retraining workflows or audit analysis.

More specifically, the system formats the record as a schema-conformant data object, such as a structured JSON payload, and appends it to a distributed message queue topic or append-only log structure. Each feedback object may include fields such as content_hash, original_label, revised_label, confidence_score, timestamp, model_version_id, session_context, and include_for_retraining. In some embodiments, additional audit metadata may be included—such as user-agent string, plugin build identifier, or interaction latency metrics—to support post hoc evaluation of labeling quality.

For example, if a user modifies a classification from “Linear Functions—Level 1” to “Quadratic Equations—Level 2,” the system serializes the update along with associated classification metadata and session details, and appends the record to a Kafka topic named retraining.feedback.v2. The message queue enforces ordering and immutability, allowing retraining scheduler 322 to periodically consume, aggregate, and score the accumulated feedback for incorporation into model update pipelines.

In certain implementations, the message queue supports partitioning based on content hash prefix or competency domain, enabling efficient parallel processing and filtering during batch model updates. The persisted feedback entries may also be tagged with retraining weight values or quality indicators derived from prior heuristic evaluation steps.

At step 710, tag for model version and feedback weighting. In various embodiments, the system appends metadata to each message queue record indicating the active model version and a retraining weight value corresponding to the system's evaluation of feedback utility. These tags enable retraining scheduler 322 to differentiate between model versions in use at the time of classification and to prioritize higher-quality feedback when constructing retraining datasets.

More specifically, the system retrieves the model version identifier-such as a unique hash or semantic version tag (e.g., v3.5.2-prod)—associated with the classification result generated in step 408 of FIG. 4. This version tag is written into the feedback record to ensure traceability and version-specific learning during subsequent retraining cycles. The system also assigns a feedback weighting score that quantifies the expected utility of the record in updating model parameters. This weighting may be computed based on multiple criteria, including the type of user correction (e.g., label replacement vs. acceptance), confidence delta between original and revised labels, or historical signal strength of similar corrections.

For example, if the original classification was assigned with 92% confidence and the user revises it to a different competency cluster, the system computes a high weighting value (e.g., 0.95) and tags the record with this score along with the current model version identifier. In contrast, if a user merely reaffirms an existing label, the system may assign a lower weighting (e.g., 0.25) to reflect reduced incremental learning value.

In certain embodiments, the system also tags feedback entries with a quality tier, derived from user interaction context or plug-in configuration (e.g., tagging as “manual override,” “batch feedback,” or “inferred correction”). These metadata enrichments allow retraining scheduler 322 to filter, prioritize, and aggregate records with fine-grained control over dataset composition, supporting model evolution without introducing label drift or degradation from ambiguous feedback.

As described above, FIG. 7 illustrates a structured process for capturing user-generated feedback, evaluating its relevance for retraining, and appending it to a feedback queue with appropriate model-version tagging. The steps are performed by plug-in 114, orchestration server 120, and categorization engine 130, as introduced in FIG. 1 and FIG. 3, and support the storage operation of step 414 in FIG. 4. In various embodiments, this feedback pipeline enables downstream refinement of classification models by preserving traceability between rendered outputs, user interactions, and the system's internal model configuration. The process ensures that updates to inference behavior reflect real-world engagement and provides a machine-executable mechanism for incorporating user-aligned corrections into the lifecycle of model development.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (A SIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Any of the above-described systems, modules, engines, components, interfaces, or the like may be implemented in hardware, software, or a combination thereof. For example, the systems introduced in FIG. 1—including plug-in 114, orchestration server 120, categorization engine 130, and persistent storage cluster 140—and the components described in FIG. 2 and FIG. 3 may each comprise one or more computing devices, virtualized environments, or containerized microservices deployed across cloud-based, on-premise, or hybrid infrastructures.

In certain embodiments, one or more components operate on client computing device(s) 110, such as through an embedded browser extension, native application module, or edge-processing environment capable of local content hashing, encryption, and interface rendering. Other components—such as orchestration server 120 or categorization engine 130—may operate in remote environments, including cloud-based compute clusters configured to perform model-based inference, maintain classification queues, and execute asynchronous retraining workflows.

Each system or component may expose one or more application programming interfaces (APIs) for structured communication with other components. These A Pls may include RESTful endpoints, remote procedure call interfaces (e.g., gRPC), or message queue handlers configured to exchange encrypted payloads, classification metadata, or feedback records. In certain implementations, A Pls may support authentication, payload validation, and schema-conformant transport mechanisms as described throughout the figures. The disclosed architecture is operable to scale based on classification volume, user concurrency, or model complexity, and may support fault-tolerant operation using load balancing, queue-based retry logic, or distributed cache invalidation across deployment environments.

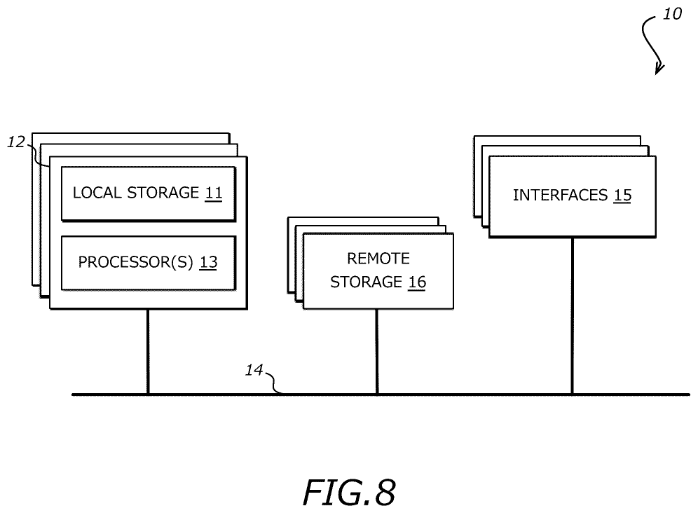

Referring now to FIG. 8, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROM s), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 8 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

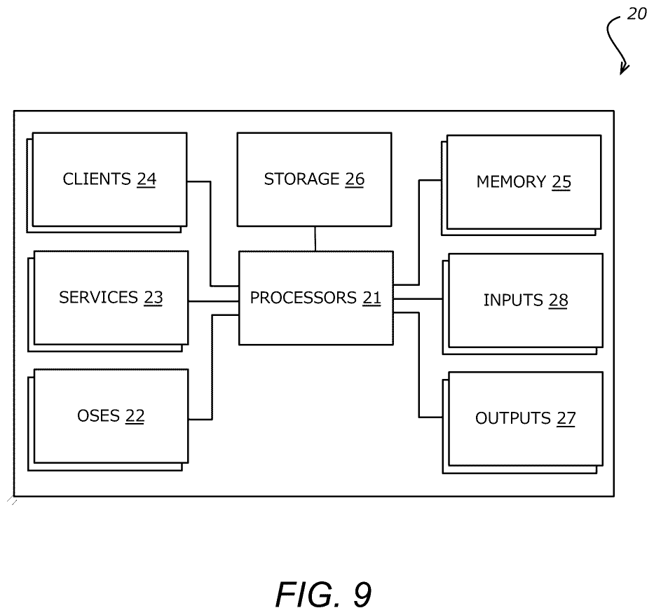

In some embodiments, systems may be implemented on a standalone computing system. Referring now to FIG. 9, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 8). Examples of storage devices 26 include flash memory, magnetic hard drive, CD-ROM, and/or the like.

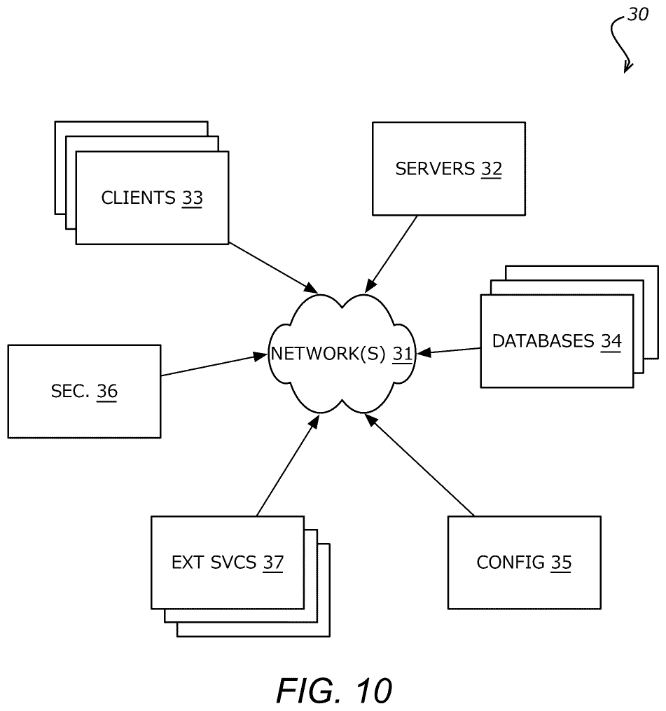

In some embodiments, systems may be implemented on a distributed computing network, such as one having any number of clients and/or servers. Referring now to FIG. 10, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 9. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

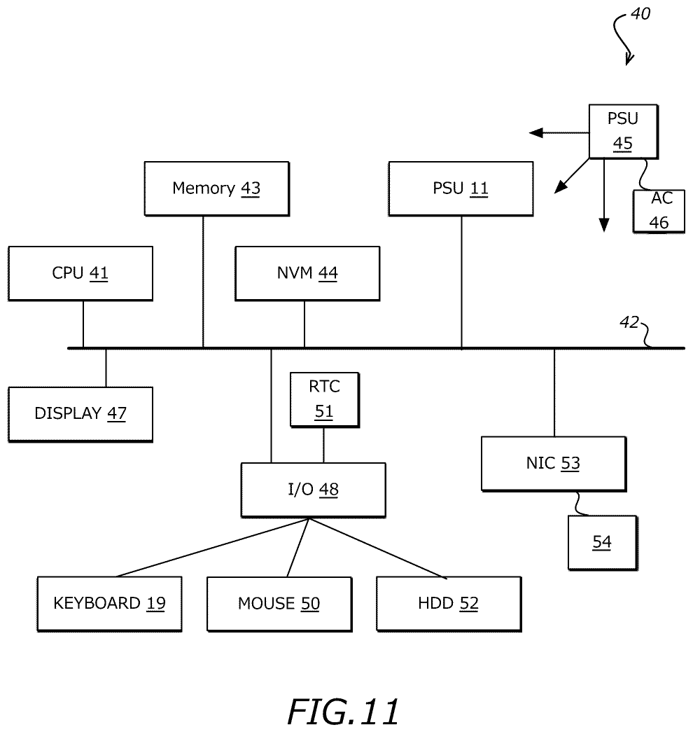

FIG. 11 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for facilitating database queries through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system for classifying learning-object content and providing encrypted classification results, the computing system comprising:
a processor; and
a memory storing instructions that, when executed by the processor, cause the computing system to:
obtain a classification request comprising a cryptographic hash of a rendered learning-object content item and associated session metadata;
determine a latent vector embedding for the learning-object content based on a model configuration;
apply one or more inference models to the latent vector embedding to determine a classification result, the classification result comprising a label, a complexity indicator, and a confidence value;
store the classification result in a cache in association with a content hash;
generate a response object comprising the classification result;
encrypt the response object using a client-specific key; and
transmit the encrypted response object for rendering in association with the rendered learning-object content item.

2. The computing system of claim 1, wherein determining the latent vector embedding comprises tokenizing the learning-object content using a subword encoding scheme and generating a vector representation using a transformer-based embedding model.

3. The computing system of claim 1, wherein applying the one or more inference models comprises:
applying a first inference model to determine a competency label, wherein the competency label indicates an educational standard or topic associated with the learning-object content;
applying a second inference model to determine a depth-of-knowledge indicator, wherein the depth-of-knowledge indicator indicates a cognitive complexity level associated with the learning-object content; and
computing a confidence metric for each inference output using a confidence calculation module, wherein the confidence metric indicates a likelihood that a corresponding inference output is accurate given an internal representation of the inference model that generated the corresponding inference output.

4. The computing system of claim 1, wherein the encrypted response object comprises a JSON Web Encryption (JWE) object containing the cryptographic hash, a timestamp, and an initialization vector.

5. The computing system of claim 1, wherein the latent vector embedding is annotated with metadata comprising a token sequence length, a vocabulary version, and an embedding model identifier.

6. The computing system of claim 1, wherein the classification result is stored in a cache using a time-to-live expiration policy and is associated with a model version identifier.

7. The computing system of claim 1, wherein encrypting the response object comprises encrypting the classification result using a cryptographic scheme that is associated with a client session.

8. The computing system of claim 1, wherein the classification result comprises one or more machine-generated labels that characterize the learning-object content based on subject-matter relevance or cognitive complexity.

9. The computing system of claim 1, wherein transmitting the encrypted response object comprises formatting the encrypted response object for rendering by a client plug-in configured to inject classification metadata into a browser-based instructional interface.

10. The computing system of claim 1, wherein the classification result enables real-time identification of an educational concept or skill identifier and an instructional complexity level associated with the rendered learning-object content item, and is operable to tag the rendered learning-object content item with metadata indicating the educational concept or skill identifier and the instructional complexity level.

11. A computer-implemented method for classifying learning-object content and providing encrypted classification results, the computer-implemented method comprising:
obtaining a classification request comprising a cryptographic hash of a rendered learning-object content item and associated session metadata;
determining a latent vector embedding for the learning-object content based on a model configuration;
applying one or more inference models to the latent vector embedding to determine a classification result, the classification result comprising a label, a complexity indicator, and a confidence value;
storing the classification result in a cache in association with a content hash;
generating a response object comprising the classification result;
encrypting the response object using a client-specific key; and
transmitting the encrypted response object for rendering in association with the rendered learning-object content item.

12. The computer-implemented method of claim 11, wherein determining the latent vector embedding comprises tokenizing the learning-object content using a subword encoding scheme and generating a vector representation using a transformer-based embedding model.

13. The computer-implemented method of claim 11, wherein applying the one or more inference models comprises:
applying a first inference model to determine a competency label, wherein the competency label indicates an educational standard or topic associated with the learning-object content;
applying a second inference model to determine a depth-of-knowledge indicator, wherein the depth-of-knowledge indicator indicates a cognitive complexity level associated with the learning-object content; and
computing a confidence metric for each inference output using a confidence calculation module, wherein the confidence metric indicates a likelihood that a corresponding inference output is accurate given an internal representation of the inference model that generated the corresponding inference output.

14. The computer-implemented method of claim 11, wherein encrypting the response object comprises encrypting the classification result using a cryptographic scheme that is associated with a client session.

15. The computer-implemented method of claim 11, wherein the latent vector embedding is annotated with metadata comprising a token sequence length, a vocabulary version, and an embedding model identifier.

16. The computer-implemented method of claim 11, wherein the classification result comprises one or more machine-generated labels that characterize the learning-object content based on subject-matter relevance or cognitive complexity.

17. The computer-implemented method of claim 11, wherein transmitting the encrypted response object comprises formatting the response for rendering by a client plug-in configured to inject classification metadata into a browser-based instructional interface.

18. A non-transitory computer-readable medium storing instructions that, when executed by one or more processors, cause a computing system to:
obtain a classification request comprising a cryptographic hash of a rendered learning-object content item and associated session metadata;
determine a latent vector embedding for the learning-object content based on a model configuration;
apply one or more inference models to the latent vector embedding to determine a classification result, the classification result comprising a label, a complexity indicator, and a confidence value;
store the classification result in a cache in association with a content hash;
generate a response object comprising the classification result;
encrypt the response object using a client-specific key; and
transmit the encrypted response object for rendering in association with the rendered learning-object content item.

19. The non-transitory computer-readable medium of claim 18, wherein determining the latent vector embedding comprises tokenizing the learning-object content using a subword encoding scheme and generating a vector representation using a transformer-based embedding model.

20. The non-transitory computer-readable medium of claim 18, wherein the classification result comprises one or more machine-generated labels that characterize the learning-object content based on subject-matter relevance or cognitive complexity, and is formatted for rendering by a client plug-in configured to inject classification metadata into a browser-based instructional interface.
